(19) United States
(12) Patent Application Publication
(10) Pub. No.: US 2011/0295915 A1
(43) Pub. Date: Dec. 1, 2011

(54) FILE MANAGEMENT APPARATUS AND FILE MANAGEMENT METHOD

(75) Inventors: Taichi EJIRI, Nagoya (JP); Masahiko HORIBE, Nagoya (JP)

(73) Assignee: BUFFALO INC., Nagoya-shi (JP)

(21) Appl. No.: 13/149,729

(22) Filed: May 31, 2011

(30) Foreign Application Priority Data
Jun. 1, 2010 (JP) 2010-125676

(51) Int. Cl. G06F 17/30

(52) U.S. Cl. 707/821; 707/E17.01

(57) ABSTRACT

In a file management apparatus, on detection of the user's file selecting action, a high-speed file processing execution program P2 gives an instruction to a cache driver D2 to read a selected target file from an external storage device and store the read target file into a cache memory CM. When a file processing operation for the selected target file is determined by the file processing program P1, the file processing program P1 gives an instruction to the cache driver D2 to write the target file, which is stored in the cache memory CM, in the memory location represented by a newly specified address in the external storage device. The file management apparatus effectively shortens the time required for executing a processing operation for a file stored in the external storage device.

### BACKGROUND OF THE INVENTION

1. Field of the Invention

The present invention relates to a file management apparatus and a file management method, for processing a file stored in an external storage device.

2. Description of the Related Art

Icons representing individual programs and files are generally used on user interfaces provided by ordinary operating systems. Functions needed by users are provided by their click or drag-and-drop of relevant icons with pointing devices, such as mouses.

For example, the user's drag-and-drop action for moving the specific icon of a selected target file from an original folder to a destination folder triggers the operation of copying or moving the target file within a single mass storage device or between different mass storage devices. As an icon-based extended user interface is a known technique of changing a processing operation to be performed through the user's preset mouse operation on a relevant icon.

File (data) reading and file writing from and into an external storage device (auxiliary storage), such as a hard disk drive, generally requires a longer time period, compared with file reading and file writing from and into an internal storage device (main storage). Accordingly, response to a request for a file processing operation, for example, a file copying operation or a file moving operation becomes rather poor.

### SUMMARY OF THE INVENTION

This invention, which has been made to solve the problem discussed above, aims to shorten the time period required for executing a processing operation for a file stored in an external storage device.

In order to solve the above-mentioned problem, the present invention is embodied in various modes of practice described below.

A first aspect of the invention provides a file management apparatus implementing a process for a file stored in an external storage device. The file management apparatus has a target file specifier for specifying a file to be processed as a target file among a plurality of files stored in the external storage device. The file management apparatus also includes a temporary storage configured to enable file reading therefrom and file writing thereto in a shorter time period than a time period required for file reading from and file writing into the external storage device, and a target file acquirer configured to read the target file from the external storage device and store the target file into the temporary storage. The file management apparatus further has a processing executer configured to perform a processing operation determined for the target file stored in the temporary storage.

The file management apparatus according to the first aspect of the invention obtains a file to be processed as a target file specified among the plural files stored in the external storage device and stores the obtained file in the temporary storage, which enables file reading therefrom and file writing thereto in a shorter time period than the time period required for file reading from and file writing into the external storage device. The file management apparatus then performs the processing operation determined for the target file stored in the temporary storage. The file management apparatus of this arrangement effectively shortens the time period required for performing a processing operation for a file stored in the external storage device.

In the file management apparatus of the first aspect of the invention, when the determined processing operation is a copying operation for the target file, the processing executer may write the target file that is stored in the temporary storage into a storage position specified as a copy destination in the external storage device. In this aspect, the target file has been stored in the temporary storage, prior to determination of a copying operation as the processing operation to be performed for the target file. This enables a copying operation on the target file to be completed within a shorter time period, compared with the reading of the target file from the external storage device after determination of a copying operation as the processing operation to be performed for the target file.

In the file management apparatus of the first aspect of the invention, when the determined processing operation is a moving operation for the target file, the processing executer may write the target file that is stored in the temporary storage into a storage position specified as a move destination in the external storage device and deletes the target file from a storage position as a move source where the target file is stored in the external storage device. In this aspect, the target file has been stored in the temporary storage, prior to determination of a moving operation as the processing operation to be performed for the target file. This enables a moving operation of the target file to be completed within a shorter time period, compared with the reading of the target file from the external storage device after determination of a moving operation as the processing operation to be performed for the target file.

In the file management apparatus of the first aspect of the invention, the file management apparatus may further include an input device used to select one or more files among the plural files. The target file specifier specifies the one or more files selected through the input device, as the target file. In this aspect the file management apparatus effectively shortens the time period required for performing a processing operation for multiple files.

In the file management apparatus of the first aspect of the invention, the input device may include a pointing device, and the target file specifier may specify the one or more files selected by the pointing device, as target files. In this aspect, the file management apparatus effectively shortens the time period required for performing a processing operation for plural files.

In the file management apparatus of the first aspect of the invention, the input device may include a pointing device, and the target file specifier may specify a file pointed by the pointing device, as a target file. In this aspect, the file management apparatus enables a target file to be specified without the user's file selecting action, thus further shortening the time period required for performing a processing operation for the target file.

In the file management apparatus of the first aspect of the invention, the file management apparatus may further include a processing operation determiner for determining a processing operation to be performed for the target file. The processing executer may perform the processing operation determined by the processing operation determiner, for the target file stored in the temporary storage. On determination of a processing operation for the target file by the processing operation determiner, the file management apparatus may perform the determined processing operation for the target file stored in the temporary storage. This effectively shortens the time period required for performing a processing operation for the target file.

In the file management apparatus of the first aspect of the invention, every time a target file is read from the external storage device, the target file acquirer may clear the temporary storage and store the read target file into the cleared temporary storage. In this aspect, the file management apparatus may effectively prevent or at least reduce potential storage capacity shortage of the temporary storage and a potential error in writing the target file in the temporary storage.

In the file management apparatus of the first aspect of the invention, the target file acquirer may clear the temporary storage after execution of the determined processing operation for the target file. In this aspect, the file management apparatus may effectively prevent or at least reduce potential storage capacity shortage of the temporary storage.

A second aspect of the invention provides a file management method of processing a file stored in an external storage device. The file management method specifies a file to be processed as a target file among a plurality of files stored in the external storage device. The file management method reads the specified target file from the external storage device and stores the read target file into a temporary storage that is configured to enable file reading therefrom and file writing thereto in a shorter time period than a time period required for file reading and file writing from and to the external storage device. The file management method then performs a processing operation determined for the target file stored in the temporary storage.

A third aspect of the invention provides a computer program product, which includes a computer-readable medium having file management program embedded therein to process a file stored in an external storage device. The file management program has a program code for specifying a file to be processed as a target file among a plurality of files stored in the external storage device. The file management program logic also has a program code for reading the specified target file from the external storage device and storing the read target file into a temporary storage that is configured to enable file reading therefrom and file writing thereto in a shorter time period than a time period required for file reading and file writing from and to the external storage device. The file management program further has a program code for performing a processing operation determined for the target file stored in the temporary storage.

The file management method according to the second aspect of the invention and the computer program product with the file management program embedded therein according to the third aspect of the invention have the similar advantages and effects to those of the file management apparatus according to the first aspect of the invention discussed above. Any one of the various aspects described above with respect to the file management apparatus of the first aspect is similarly adopted for the file management method of the second aspect, as well as for the computer program product of the third aspect. The computer-readable medium included in the computer program product to record the file management program therein may be any one of diverse computer-readable media, for example, a CD, a DVD, or an HDD.

### BRIEF DESCRIPTION OF THE DRAWINGS

FIG. 1 schematically shows the general configuration of a file management apparatus according to one embodiment of the invention;

FIG. 2 shows in block diagram the internal construction of the file management apparatus of the embodiment;

FIG. 3 shows the software configuration of the file management apparatus of the embodiment in the form of functional blocks;

FIG. 4 is the flowchart of a high-speed file processing routine performed in the file management apparatus of the embodiment;

FIG. 5 illustrates one example of file selection on the display screen;

FIG. 6 illustrates i one example of determination of a file processing operation on the display screen;

FIG. 7 shows the difference between a high-speed file processing flow of the embodiment and a conventional file processing flow, observed prior to determination of a file processing operation;

FIG. 8 shows the difference between a high-speed file processing flow of the embodiment and a conventional file processing flow, observed after determination of a file processing operation;

FIG. 9 illustrates another example of file selection on the display screen;

FIG. 10 illustrates still another example of file selection on the display screen;

FIG. 11 illustrates one example of selecting all files by folder selection on the display screen;

FIG. 12 illustrates another example of determination of a file processing operation on the display screen;

FIG. 13 shows the software configuration of another file management apparatus as one modification in the form of functional blocks; and

FIG. 14 shows available positions of a cache driver in the file management apparatus of the embodiment.

### DESCRIPTION OF EMBODIMENTS

### Configuration of File Management Apparatus

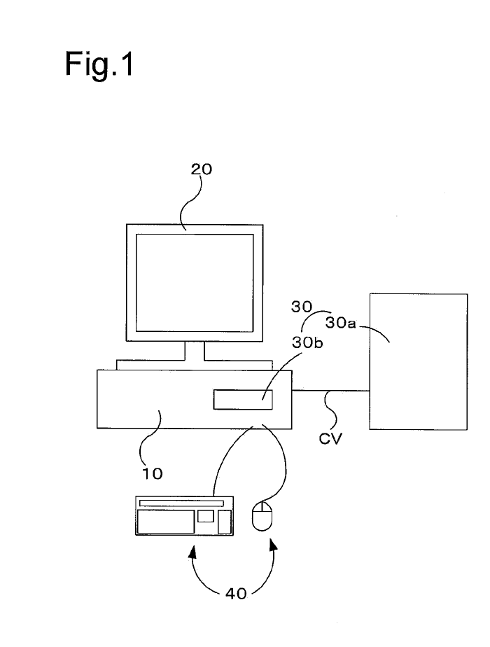

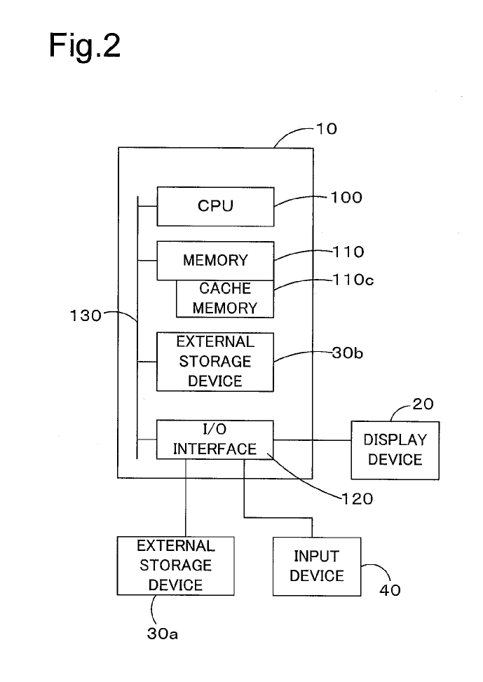

FIG. 1 schematically shows the general configuration of a file management apparatus 10 according to one embodiment of the invention. FIG. 2 shows in block diagram the internal construction of the file management apparatus 10 of the embodiment. The file management apparatus 10 of the embodiment includes a display device 20, an external storage device 30, and an input device 40. The external storage device 30 may be a mass storage device 30a provided in a different casing separately from the file management apparatus 10 or a mass storage device 30b built in the file management apparatus 10. The mass storage device 30a provided separately in the different casing is connected with the file management apparatus 10 by means of a cable CV.

The file management apparatus 10 is a general-purpose personal computer, for example, and includes a central processing unit (CPU) 100, a memory 110, a cache memory 110c, an input-output (I/O) interface 120, an internal bus 130, and the external storage device 30b, as shown in FIG. 2. The CPU 100, the memory 110, the cache memory 110c, the input-output (I/O) interface 120, and the external storage device 30b are interconnected via the internal bus 130 in a mutually communicable manner. The memory 110 of this embodiment includes a volatile semiconductor memory (random access memory) and a non-volatile semiconductor memory (read only memory) referred to as a main storage or a temporary storage, respectively. Part of the memory 110 may serve as the cache memory 110c. The cache memory 110c may be integrated with the CPU 100. The cache memory 110c herein represents a storage having a shorter time for accessing by the CPU 100, i.e., a time period required for data reading therefrom and data writing thereto, shorter than a time for access by the external storage device 30.

The CPU 100 loads an application program stored in either the external storage device 30 or the read only memory onto the random access memory and performs various processes according to the loaded application program. The input-output interface 120 is a physical interface to connect peripheral devices, such as the display device 20, the external storage device 30a, and the input device 40, with the file management device 10 and may include a USB (universal serial bus) port, a serial port, a parallel port, an SCSI (small computer system interface) port, and other ports. Each of the peripheral devices is controlled via the input-output interface 120 by the corresponding device driver stored in either the memory 110 or the external storage device 30.

The display device 20 displays graphical user interfaces (GUIs) during execution of various file processing operations by the file management apparatus 10. For example, the graphical user interface displayed on the display device 20 may include icons representing respective files, an icon representing a folder as a copy destination or a move destination or a file list window provided by a file management application program as described later.

The external storage device 30 is a mass storage device and may consists of, for example, one or more hard disk drives or flash memories. The external storage device 30 may be used as a storage for storing an operating system and application programs or as a storage for storing files. The external storage device 30 is referred to as auxiliary storage or secondary storage, while the memory 110 is referred to as main memory or primary storage.

The input device 40 includes a keyboard and a pointing device, such as a mouse, and is used to input the user's requests or instructions in the file management apparatus 10. In this embodiment, the user may select a file to be processed as a target file through a mouse click, and drag and drop the target file onto a selected folder with the mouse in order to specify the selected folder as the copy destination or the move destination of the target file, and determine a desired processing operation for the target file. Alternatively the user may operate the keyboard to select a target file on a file list window provided by the file management application program, determine a desired file processing operation (for example, a copying operation or a moving operation), and specify a copy destination or a move destination for the target file. The processing operation for the target file to be determined by the user's drag-and-drop action may be selected in advance by the file management application program. For example, the file processing operation to be determined by the drag-and-drop action may be selected in advance depending on the type of drag-and-drop action; for example, a drag-and-drop action within a single external storage device corresponds to a moving operation for the target file and a drag-and-drop action between different external storage devices corresponds to a copying operation for the target file. In another example, the user may select a desired file processing operation when a dragged target file is to be dropped.

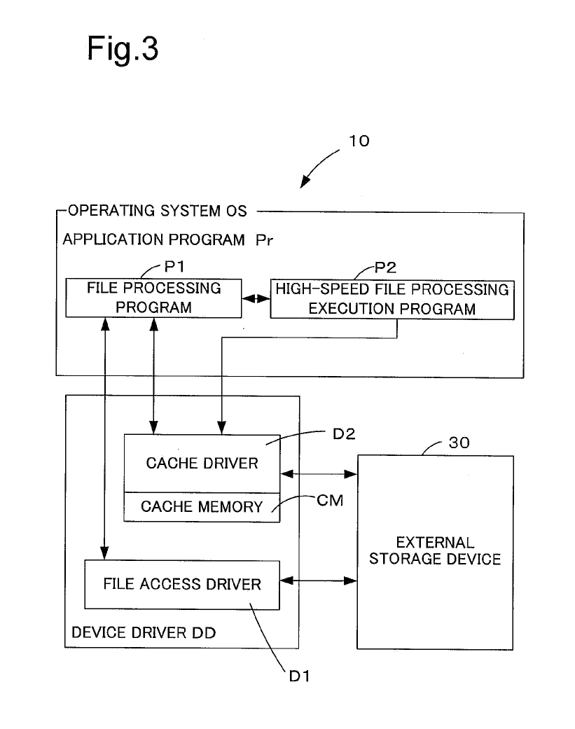

FIG. 3 shows the software configuration of the file management apparatus 10 of the embodiment in the form of functional blocks. The file management apparatus 10 has an operating system OS and a device driver DD as software components. The operating system OS is a basic program to operate the hardware components of the file management apparatus 10 and provides application programs with interfaces for operating the hardware components. A file processing program P1 and a high-speed file processing execution program P2 are activated as an application program Pr on the operating system OS. The device driver DD includes at least a file access driver D1 and a cache driver D2.

The file processing program P1 is used to manage various files stored in the external storage device 30 and perform any one of various file processing operations, for example, displaying a list of files in a folder unit and copying, moving, or clearing (deleting) a selected file, via the file access driver D1 in response to the user's input instruction. The file processing program P1 serves as the processing operation determiner. The file processing operation of this embodiment is either a file copying operation or a file moving operation and accordingly represents the instruction of reading a selected file stored in the external storage device 30 from a selected folder (address) and writing the selected file in a specified folder (address). The file processing program P1 may be an explorer installed on the operating system OS or may be any one of various file processing programs provided as the application program Pr.

The high-speed file processing execution program P2 is used to enable a high-speed file copying operation or a high-speed file moving operation via the cache driver D2 and is started by, for example, the activation of the file processing program P1. The high-speed file processing execution program P2 serves as the target file specifier to detect the user's file selection or file specification during the execution of the file processing program P1 and read the selected or specified file from the external storage device 30 and store the read file into a cache memory CM via the cache driver D2 prior to the determination of a file processing operation. To be concrete, under the operating system of Windows (registered trademark), SetWindowsHookEX( ) function as one of API functions is executed on activation of the file processing program P1. A system message corresponding to the user's file selecting action with is then sent through the input device 40 to the high-speed file processing execution program P2, which is thus allowed to detect the user's file selecting action prior to the determination of a file processing operation. In response to the detection of the user's file selecting action, the high-speed file processing execution program P2 gives an instruction to the cache driver D2 to read a selected file and store the read file into the cache memory CM and sends a system message to the file processing program P1.

The file access driver D1 receives an instruction from the file processing program P1 and performs a file reading operation from or a file writing operation into, the external storage device 30. The file access driver D1 accordingly has the function of conversion between a logic address specified by the file processing program P1 and a physical address in the external storage device 30. The file access driver D1 also has the function of relating one or plural sector data stored in sector units in the external storage device 30 to one file and providing the file processing program P1 with the sector data related to the one file. In an ordinary file processing flow, in response to an instruction for performing a file processing operation specified by the file processing program P1, the file access driver D1 reads a selected target file from the external storage device 30, stores the read target file into a cache memory, and writes the target file, which is stored in the cache memory, onto a folder specified as either a copy destination or a move destination.

In a file processing flow of this embodiment, on the other hand, during the execution of the high-speed file processing execution program P2, the cache driver D2 performs the file access function, in place of the file access driver D1. The cache driver D2 accordingly serves as the target file acquirer. In response to the detection of the selection of a target file, the cache driver D2 receives an instruction from the high-speed file processing execution program P2 to read a selected target file from the external storage device 30 and store the read target file into the cache memory CM. On determination of a file processing operation by the file processing program P1, the cache driver D2 writes the target file, which is stored in the cache memory CM, in the memory location represented by a specified address in the external storage device 30 in accordance with the determined file processing operation. On determination of a file processing operation for a selected target file, the file processing program P1 reads the target file stored in the cache memory CM and writes the read target file into the external storage device 30 via the cache driver D2. Only the operation of writing the target file into the external storage device 30 may be performed via the file access driver D1, instead of the cache driver D2.

### High-Speed File Processing

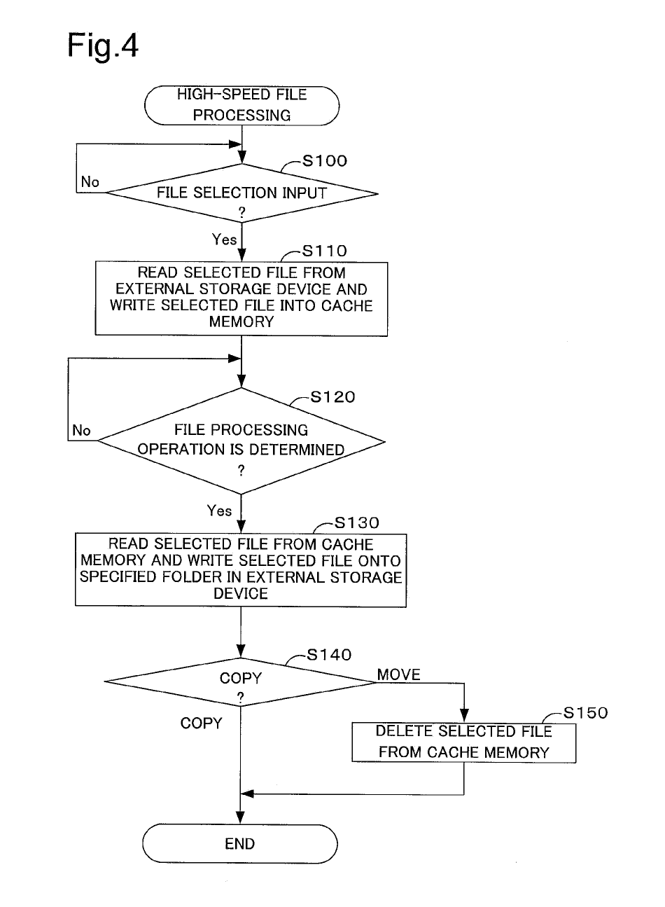

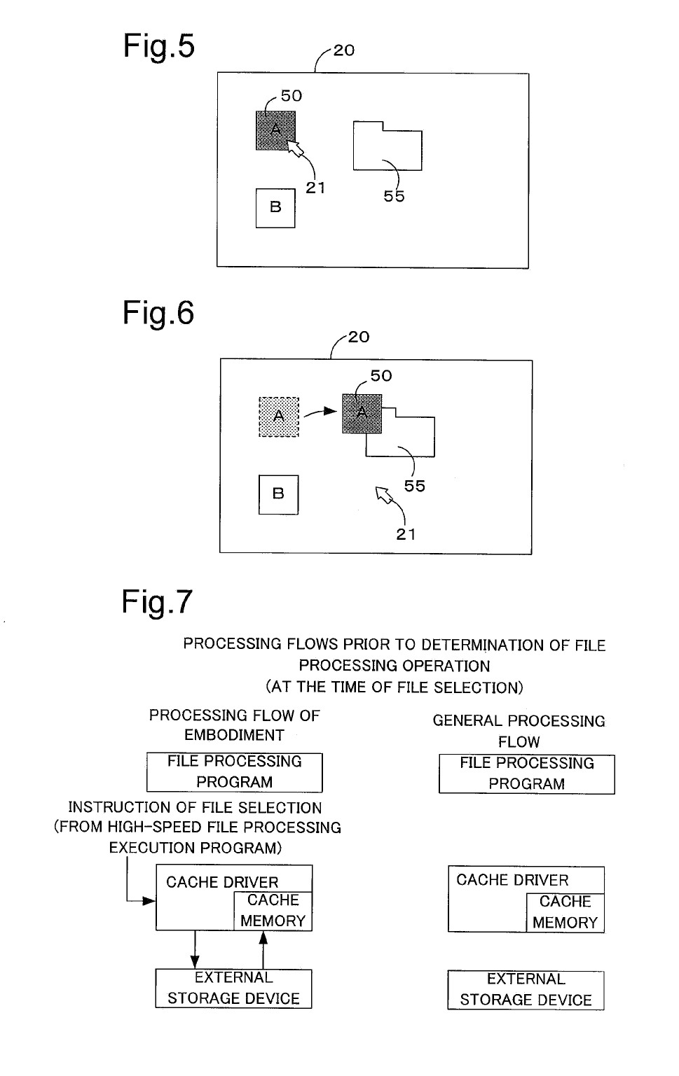

FIG. 4 is a flowchart for a high-speed file processing routine performed in the file management apparatus 10 of the embodiment. FIG. 5 illustrates one example of file selection on the display screen. FIG. 6 illustrates one example of determination of a file processing operation on the display screen. On reception of the user's execution request for the file processing program P1 via the input device 40, the file management apparatus 10 (CPU 100) activates the high-speed file processing execution program P2 and waits for a file selection input from the input device 40 (step S100: No). In response to the user's selection of a target file 50 by pointing with a mouse pointer 21 as shown in FIG. 5, the CPU 100 detects a file selection input (step S100: Yes) and activates the cache driver D2 to read the selected target file from the external storage device 30 and store the read target file into the cache memory 110c. Not only one file but also a plurality of files may be selected as the target file at this moment. In the illustration of FIG. 5, the currently selected target file 50 is highlighted in a different color. In subsequent drawings, the object highlighted in a different color indicates that it is selected.

The file selection input is detected according to the following procedure. As explained above, the preliminary execution of the SetWindowsHookEx( ) function enables the high-speed file processing execution program P2 to detect a system message corresponding to the user's file selecting action by the input device 40, prior to the file processing program P1. When the user clicks the mouse while the target file 50 is being pointed with the mouse pointer 21, the operating system OS sends a system message corresponding to the user's file selecting action to the high-speed file processing execution program P2. In response to the reception of this system message, the high-speed file processing execution program P2 sends a system message corresponding to the file selecting action to the file processing program P1 to trigger a series of file processing operations by the file processing program P1.

The CPU 100 waits for the determination of a file processing operation (step S120: No). On determination of a file processing operation by the file processing program P1 (step S120: Yes), the CPU 100 activates the cache driver D2 to read the selected target file from the cache memory 110c and write the read target file into a specified folder in the external storage device 30 (step S130). For example, the file processing operation may be determined by the user's mouse operation to select a desired command, for example, “Copy” or “Move”, in a displayed menu of available options after the selection of the target file. In another example, the user may drag the selected target file 50 with the mouse pointer 21 and drop the dragged target file 50 onto a destination folder 55 as shown in FIG. 6 to determine the file processing operation. In the application of determining the file processing operation by the user's drag-and-drop action, the file processing operation to be determined by the drag-and-drop action may be set in advance depending on the type of the drag-and-drop action; for example, a drag-and-drop action within a single external storage device corresponds to the g operation of moving the target file and the action of dragging and dropping between different external storage devices corresponds to the operation of copying the target file, as discussed previously.

When the determined file processing operation is a copying operation (step S140: Copy), the CPU 100 terminates this high-speed file processing routine. When the determined file processing operation is not a copying operation but a moving operation (step S140: Move), on the other hand, the CPU 100 clears or deletes the stored target file from the cache memory 110c (step S150) and terminates this high-speed file processing routine. The step of clearing or deleting the stored target file from the cache memory may be excluded from this processing routine. The file stored in the cache memory may be cleared in any one of various other conditions.

The “read-ahead” file stored in the cache memory prior to the determination of a file processing operation may be handled in the following manner.

### [Processing Flow on Reception of Cancellation of Processing Target File]

When the file processing program P1 receives and accepts the cancellation of processing a target file, a cancellation request for the target file may be sent from the file processing program P1 to the high-speed file processing execution program P2. The high-speed file processing execution program P2 may then give an instruction to the cache driver D2 to clear or delete the target file stored in the cache memory CM. In an application where the high-speed file processing execution program P2 has only the function for the “read-ahead” of a target file and the file processing program P1 is accessible to the cache driver D2, the file processing program P1 may give an instruction to the cache driver D2 to delete or clear the target file stored in the cache memory CM.

[Processing Flow after Elapse of Preset Time Period]

In an application where the file processing program P1 is inaccessible to the cache driver D2, on the other hand, the cache driver D2 may be designed to clear or delete the target file stored in the cache memory CM after the elapse of a preset time period. The cache memory CM may be cleared after the elapse of the preset time period according to any one of adequate procedures as discussed below.

A cache driver of a variable working cache size may monitor time, for example, by a timer and clear or delete a target file that is stored in the cache memory CM but is not used for the preset time period. The deletion of an unused file preferably saves unnecessary memory usage. A cache driver of a fixed working cache size designed to be overwritten every time a newt file is transferred, may continue to store the currently existing file until the transfer of a new file for storage.

### [Processing Flow on Selection of New File]

In the cache driver of the fixed working cache size, when there is any vacant space, a new file is written into the vacant space. When there is no vacant space, on the other hand, one procedure may overwrite the oldest cache data in a storage area with a new file and thereby delete the oldest cache data. Another procedure may delete old cache data from a storage area and subsequently write a new file into the storage area. A cache driver with an advanced algorithm may assign priority to cache files stored therein based on the access frequency or the total access time for each cache file and delete cache files in ascending order in priority. For example, a higher priority is given to a cache file having a higher access frequency or a longer total access time.

In another application, the cache driver D2 may delete a cached target file kept in the cache memory CM every time a new target file is read from the external storage device 30. In still another application, the cache driver D2 may delete a cached target file kept in the cache memory CM every time a determined processing operation has been completed for the target file kept in the cache memory CM.

As described above, in the file management apparatus 10 of the embodiment, on selection of a target file, the high-speed file processing execution program P2 activates the cache driver D2 to read the selected target file from the external storage device 30 and store the target file into the cache memory CM. Immediately after the determination of a processing operation for the target file, the determined processing operation can thus be performed and completed. Prior to the determination of a processing operation for a selected target file, the file management apparatus 10 of the embodiment reads the target file from the external storage device 30, which requires a longer time period for file reading and file writing, and stores the read target file into the cache memory CM, which requires a shorter time period for file reading and file writing. Immediately after the determination of the processing operation, the target file can thus be written (copied or moved) in the memory location represented by a specified address. This advantageous feature of the embodiment is described more concretely below.

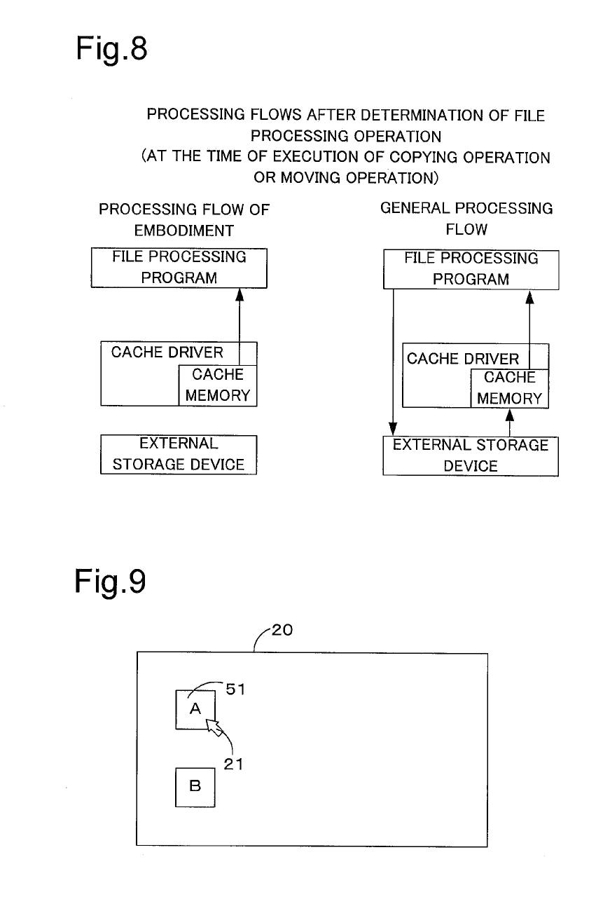

FIG. 7 illustratively shows the difference between a high-speed file processing flow of the embodiment and a conventional file processing flow, observed before the determination of a file processing operation. FIG. 8 illustratively shows the difference between the high-speed file processing flow of the embodiment and the conventional file processing flow, after the determination of the file processing operation.

In the conventional file processing flow shown in FIG. 7, at the time of file selection, i.e., prior to the determination of a file processing operation, a file processing program has no access to an external storage device. In the file management apparatus 10 of the embodiment, on the other hand, in response to the file selecting operation, the high-speed processing execution program gives an instruction for the “reading ahead” of a selected target file to the cache driver. On reception of this instruction, the cache driver “reads ahead” the selected target file from the external storage device and stores the “read-ahead” target file into the cache memory. The cache driver of this embodiment has the function of a file access driver, and therefore can respond to a logical target file reading instruction, access to a corresponding physical address in the external storage device, and obtain sector data of the target file. As well known in the art, time required for data reading and data writing from and to a cache memory (time for accessing a cache memory) is extremely shorter than time required for data reading and data writing from and to an external storage device (time for accessing an external storage device).

In the conventional file processing flow shown in FIG. 8, at the time of executing a copying operation or a moving operation, i.e., only after the determination of a file processing operation, the file processing program gives an instruction for reading a selected target file to a file access driver (not shown). The target file read from the external storage device is stored in a cache memory and is subjected to the determined file processing operation executed by the file processing program. To put it concretely, the read target file is written in a copy destination folder or a move destination folder in the external storage device via the file access driver.

In the file management apparatus 10 of the embodiment, on the other hand, at the time of determination of a file processing operation, the selected target file has already been stored in the cache memory. The file processing program writes the target file, which is stored in the cache memory, in a copy destination folder or a move destination folder in the external storage device via the cache driver or the file access driver. The processing flow of this embodiment preferably eliminates or at least reduces time required for writing a selected target file into the cache memory at the time of determination of a file processing operation. This effectively shortens a time period required for a file copying operation or a file moving operation.

### Modifications

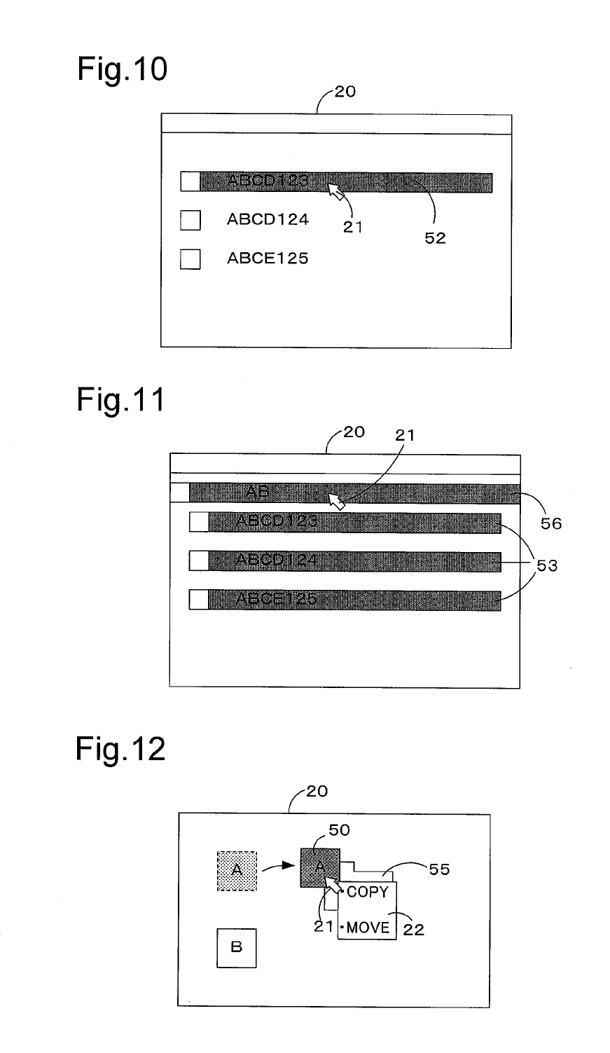

(1) In the embodiment described above, the selection of a target file by the mouse pointer 21 is the event that triggers the “reading ahead” of the selected target file from the external storage device and storing the “read-ahead” target file in the cache memory. Any one of other adequate events may serve as the trigger of “reading ahead” the target file as shown in FIGS. 9 and 10.

In one illustrated example of FIG. 9, “mouseover” of the pointer 21 on a selected target file 51, i.e., event of moving the mouse pointer over the target file 51, on the display screen of the display device 20 serves as the trigger of “reading ahead” the target file. The target file 51 is not highlighted in a different color in the illustration of FIG. 9, since the target file 51 has not been clicked for selection. Prior to the selection of the target file 51, the mouse pointer 21 is moved over the target file 51 to be selected. At this timing, the target file 51 is “read ahead” and stored in the cache memory. This operation further shortens the total time required for file processing.

In this modified application involving the “mouseover” of the mouse pointer 21 on the selected target file 51 serving as the trigger event, the SetWindowsHookEx( ) function is executed in advance to enable the detection of a mouse move and a mouse position. The window of the file processing program is detected by the EnumWindows( ) function or the FindWindow( ) function. The path to a folder being displayed is obtained on the basis of titles or other relevant factors. Whenever the mouse pointer 21 moves, the coordinates of the mouse pointer 21 are obtained. The WindowFromPoint( ) function is activated to determine whether an explorer window is present at the position of the mouse pointer 21. When an explorer window is present, the file name of the icon (file) on which the mouse pointer 21 is located is identified. The address (full path) of the target file is obtained by combining the obtained folder path with the identified file name.

In another illustrated example of FIG. 10, a target file 52 is selected from among the displayed list of files provided by the file processing program on the display screen of the display device 20 through the user's operation of the keyboard or the mouse. In the example of FIG. 10, respective files are not shown as icons but in the form of a list. In this application, a file selected by the mouse pointer 21 or a file under “mouseover” of the mouse pointer 21 is “read ahead” as a target file from the external storage device and is stored in the cache memory. Instead of file selection by the mouse, a target file may be selected by using arrow keys on the keyboard.

(2) In the above embodiment, one individual file included in a folder is selected as the target file. As shown in FIG. 11, an object to be copied or to be moved may be selected per folder. In one illustrated example of FIG. 11, an object folder 56 is selected in a file list window provided by the file processing program on the display screen of the display device 20, so as to select all files 53 included in the selected object folder 56. In this modified application of selecting all files by selecting an object folder, the window of the file processing program is detected by the EnumWindows( ) function or the FindWindow( ) function, and the path to the folder being displayed is obtained on the basis of titles or other relevant factors. An API function, such as the FindFirstFile( ) function, is used to obtain a list of files, irrespective of the file processing program.

(3) In the above embodiment, either a copying operation or a moving operation is set at the time of determination of a file processing operation or is set corresponding to a drag-and-drop action of a file within a single external storage device or between different external storage devices. As shown in FIG. 12, during the action of dragging and dropping a target file 50 onto a folder 55 on the display screen of the display device 20, either a copying operation or a moving operation is determined by the user's selection on a menu 22.

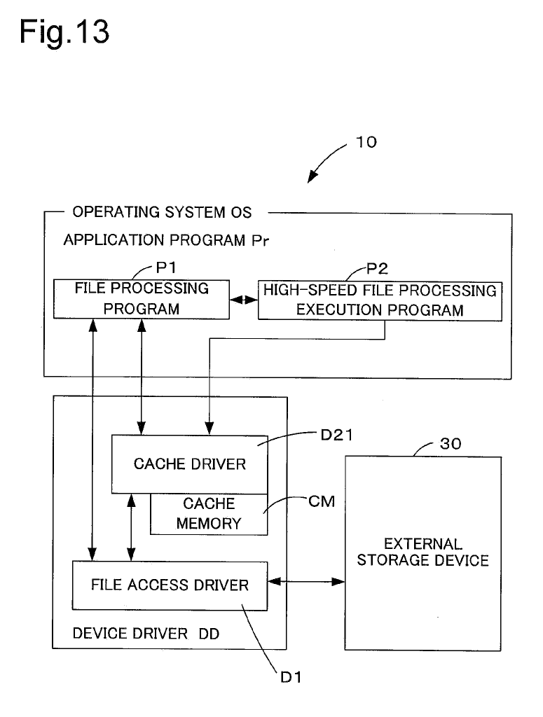

(4) The configuration of the above embodiment has the cache driver D2 designed to have the function of the file access driver D1. A target file may be “read ahead” by the combined operation of a cache driver and a file access driver. FIG. 13 shows the software configuration of another file management apparatus as one modification in the form of functional blocks. In the software configuration of FIG. 13, the high-speed file processing execution program P2 detects the user's selection or specification of a target file during the execution of the file processing program P1, and gives an instruction to a cache driver D21 in cooperation with the file access driver D1 to read the selected or specified target file from the external storage device 30 and store the read target file in the cache memory CM, prior to determination of a file processing operation.

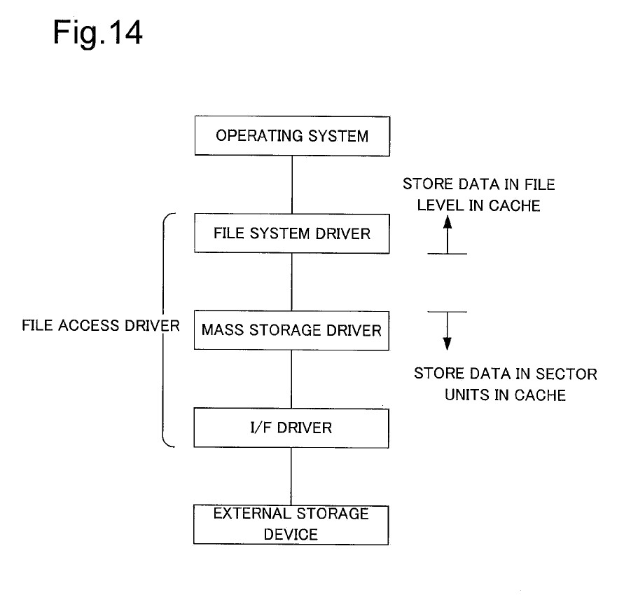

(5) The configuration of the above embodiment has the cache driver D2 in an upper layer above the file access driver D1 and stores a selected target file in the cache memory CM. One modified configuration may have a cache driver D21 in a lower layer below a file access driver D1 and store a selected target file in a cache memory. In this modified configuration, the high-speed file processing execution program P2 gives an instruction of “reading ahead” a selected target file to the cache driver provided in the lower layer below the file access driver. FIG. 14 schematically shows the available positions of a cache driver in the file management apparatus of the embodiment. For the simplicity of explanation, a group of drivers required for making access to the external storage device 30 is collectively referred to as the “file access driver” in the above embodiment. In order to allow the operating system OS or the application program Pr to have access to the external storage device 30 and read or write a file from or into the external storage device 30, the file access driver should include diversity of drivers such as, for example, a file system driver, a mass storage driver, and an I/F driver. The file system driver enables data in a file stored in sector units to be handled in a file unit or a file level. The mass storage driver recognizes and controls a USB device as a storage device and is required when the external storage device 30 is connected to the file management device 10 via a USB interface. The I/F driver makes the required conversion of a control signal corresponding to an interface of the external storage device 30. The I/F driver is the device that is affected by the external storage device 30 to the greatest extent. In the case where the cache driver is provided in a lower layer below the file system driver, cache drivers should be provided corresponding to individual external storage devices or more specifically to respective device drivers of the individual external storage devices. It is thus desirable to provide the cache driver in an upper layer above the file system driver (file access driver).

In the external storage device 30, files are generally stored in discrete or discontinuous address portions in sector units and may be handled in a file unit only via the file system driver having the file system functions. The file system driver uses a pointer table for addressing sectors of a file. When the file management apparatus 10 (file processing program) specifies a file, the file system driver refers to a pointer table related to the specified file to read data of the files in sector units, and provides the file processing program with the read data in a file unit. In the case where the cache driver D2 is provided in the upper layer above the file system driver, the data of the “read-ahead” file in sector units are stored per file unit into the cache memory. In the case where the cache driver is provided in the lower layer below the file system driver (i.e., closer to the external storage device), however, the data of the “read-ahead” file in sector units cannot be handled in a file unit but are stored in sector units into the cache memory. Storage of data in sector units assures effective use of the storage area in the cache memory.

(6) In the configuration of the above embodiment, the file processing program is provided separately from the high-speed file processing execution program. The file processing program may be designed to include the function of the high-speed file processing execution program. In this modified configuration, the high-speed file processing is achieved by the single file processing program.

(7) In the above embodiment, the file copying operation and the file moving operation are explained as examples of the file processing operation. The file processing operation is, however, not restricted to these examples. Another example of the file processing operation is the activation of an application program related to a file. For example, the user's drag-and-drop of the icon of a target file onto the icon of an execution file (application program) may activate the application program. In a general processing flow, after the activation of the application program, the application program reads the dragged and dropped target file from the external storage device. There is accordingly some time elapsed before the target file is opened by the activated application program. In the file management apparatus 10 of the embodiment, on the other hand, on selection of a target file, the target file is stored in the cache memory. The configuration of the embodiment thus effectively shortens the time elapsing before the target file is opened by the application program.

(8) In the configuration of the above embodiment, the cache driver D2 has the read-cache function of reading a file and storing the read file into the cache memory. In an application where a cache driver without the read-cache function is used, the high-speed file processing execution program gives an instruction to the cache driver to store an obtained file into the cache memory.

The present invention has been described hitherto in detail by way of the preferable embodiment and its modifications. The embodiment and its modifications are, however, to be considered in all aspects as illustrative for the purpose of better understanding of the invention and not restrictive. Many other modifications, changes, alterations will occur to those skilled in the art, without departing from the scope and spirit of the main characteristics of the present invention. All such modifications, changes and alterations are to be understood as restricted only by the disclosure of the attached claims.

What is claimed is:

1. A file management apparatus for processing a file stored in an external storage device, the file management apparatus comprising:
a target file specifier for specifying a file to be processed as a target file among a plurality of files stored in the external storage device;
a temporary storage capable of loading and unloading files in time shorter than the time required for the external storage device to load and unload files;
a target file acquirer for reading the target file from the external storage device and storing the target file in the temporary storage; and
a processing executer for performing a processing operation determined for the target file stored in the temporary storage.

2. The file management apparatus in accordance with claim 1, wherein when the determined processing operation is a copying operation for the target file, the processing executer writes the target file that is stored in the temporary storage, into a storage position specified as a copy destination in the external storage device.

3. The file management apparatus in accordance with claim 1, wherein when the determined processing operation is a moving operation for the target file, the processing executer writes the target file that is stored in the temporary storage, into a storage position specified as a move destination in the external storage device and deletes the target file from a storage position as a move source where the target file is stored in the external storage device.

4. The file management apparatus in accordance with claim 1, further comprising:
an input device used to select one or more files from among the plural files,
wherein the target file specifier specifies the one or more files selected by the input device, as the target file.

5. The file management apparatus in accordance with claim 4, wherein the input device is a pointing device, and
the target file specifier specifies the one or more files selected by the pointing device, as the target file.

6. The file management apparatus in accordance with claim 4, wherein the input device is a pointing device, and
the target file specifier specifies a file pointed out by the pointing device, as the target file.

7. The file management apparatus in accordance with claim 1, further comprising:
a processing operation determiner for determining a processing operation to be performed for the target file,
wherein the processing executer performs the processing operation determined by the processing operation determiner, for the target file stored in the temporary storage.

8. The file management apparatus in accordance with claim 1, wherein each time a target file is read from the external storage device, the target file acquirer clears the temporary storage and stores the read target file in the cleared temporary storage.

9. The file management apparatus in accordance with claim 1, wherein the target file acquirer clears the temporary storage after the execution of the determined processing operation for the target file.

10. A file management method of processing a file stored in an external storage device, comprising the steps of:
specifying a file to be processed as a target file among a plurality of files stored in the external storage device;
reading the specified target file from the external storage device and storing the read target file in a temporary storage, the temporary storage being capable of loading and unloading files in time shorter than the time required for the external storage device to load and unload files; and
performing a processing operation determined for the target file stored in the temporary storage.

11. A computer program product, comprising:
a computer-readable medium having file management program embedded therein to process a file stored in an external storage device,
the file management program comprising:
a program code for specifying a file to be processed as a target file among a plurality of files stored in the external storage device;
a program code for reading the specified target file from the external storage device and storing the read target file into a temporary storage, wherein the temporary storage is configured to enable file reading therefrom and file writing thereto in a shorter time period than a time period required for file reading from and file writing into the external storage device; and
a program code for performing a processing operation determined for the target file stored in the temporary storage.
